(19) United States
(12) Patent Application Publication
(10) Pub. No.: US 2007/0141302 A1
(43) Pub. Date: Jun. 21, 2007

(54) Method of applying adhesive

(76) Inventor: Michael Theurl, Lienz (AT)

Correspondence Address: Thomas M. Saunders;Brown Rudnick Berlack Israels LLP, One Financial Center, Box IP, Boston, MA, 02111, US

(21) Appl. No.: 11/698,652

(22) Filed: Jan. 26, 2007

Related U.S. Application Data
(63) Continuation of application No. PCT/AT05/00292, filed on Jul. 26, 2005.

(30) Foreign Application Priority Data
Jul. 30, 2004 (AT) A 1312/2004

(51) Int. Cl. B05D 1/02; B32B 3/12

(52) U.S. Cl. 428/116; 427/427.3; 428/198; 428/194

(57) ABSTRACT

This invention involves a method for applying adhesive to the narrow side of thin, film-type workpieces, in particular veneer strips or sheets, wherein the workpiece and at least one nozzle dispensing the adhesive substantially perpendicular to the narrow side of the workpiece are guided at a short distance from each other, characterized in that the adhesive is dispensed by the nozzle in the form of dosed droplets.

The invention relates to a method of applying adhesive to the narrow side of thin, film-type workpieces, in particular veneer strips or sheets, wherein the workpiece and at least one nozzle dispensing the adhesive substantially perpendicular to the narrow side of the workpiece are guided at a short distance from each other.

Although some inventions already relate to the application of adhesive using a nozzle, common practice predominantly comprises the application of adhesive to a stack of veneer material. Several veneer sheets are laid one on top of the other and in most cases the longitudinal edges of the veneers in the stack are cemented or glued via contact with an applicator roll which applies the adhesive to the veneer edge. As the applicator roll can only insufficiently prevent the adhesive from travelling from the edge onto the veneer surface, especially in the case of undulating veneers, the veneer sheets lying one on top of the other stick together and thus their mechanical separation frequently results in the edge area being damaged and the appearance of the subsequently broad side of the veneer being spoiled. Even where individual strips are already glued by means of an applicator roll in the longitudinal passage, a lack of accurate dosing possibilities results in the adhesive travelling and spilling out or in incorrect gluing if a gap forms relative to the applicator roll.

Because of this problem, it is attempted in already known devices or methods (cf. DE 35 10 147) to so design the application of adhesive by means of a nozzle before compression in the assembly machine that a bead- or lozenge-shaped deposit of adhesive is introduced from above, vertically or horizontally in the direction of application between the two edges guided parallel at a small distance of the veneer sheets to be glued, wherein a supporting surface represents the lower limit. Together with the two side edges the supporting surface forms in cross-section a channel which the glue bead fills.

This device creates in contact-less fashion by means of a nozzle a continuously applied thread-like cross-section of a glue bead which is dosed such that it does not spill out when both edges are pressed together. It is also, difficult to have the current distance between the two workpiece edges in the nozzle area correspond accurately to the necessary bead thickness.

Since the application movement of the adhesive takes place, not directly onto the workpiece edges, but perpendicular thereto onto the supporting surface, and the adhesive bead is removed from the supporting surface by peeling only as a result of bringing the veneer edges together, here too the adhesive can travel onto the veneer surface. It is also to be expected that the supporting surface will become increasingly contaminated by the constant wetting.

In known devices of the type defined at the outset (cf. WO 02068163) the adhesive is already applied by means of a nozzle frontally, i.e. perpendicular to the veneer edge to be bonded. It is attempted to achieve the required high application and dosing accuracy by means of very small distances, wherein the possibility is not ruled out that the veneer edge joins onto the nozzle opening.

In this connection the objective is also met that when gluing veneers it is important that neither before nor after the compression adhesive escapes alongside the edge to be glued onto the subsequently visible veneer surface, and that the veneers are moved past the nozzle device at relatively high speeds during the application of adhesive or glue. Guides are also used with this device in order to achieve a precise positioning of the veneer edge during the application of adhesive with respect to the nozzle opening.

Due to this device, it is true that the position of the veneer sheets moved past lengthwise in the plane of the application movement is accurately defined by means of guide devices located above and below the nozzle opening, the distance from the nozzle opening, however, can vary. Due to the small size of the glue application, usually 0.2-0.3 mm for a veneer thickness of 0.5 mm, the distance should be very small. The narrow veneer edge can even touch the nozzle opening.

Therefore no specific allocation of an application result is possible, especially as the requirements vary greatly between a contact-less application and a contact application. Nor is it understood why the problem of the travelling of adhesive onto the broad side can be prevented by a small distance alone, especially as a jam of adhesive can occur if there is touching (narrowing) of the nozzle opening. Therefore it is also not possible to assume a constant application of adhesive with a uniform adhesive bead.

Thus the object of the invention is to further develop a method of the type described at the outset for applying adhesive such that even when the application rate is high and the application edge is very narrow and undulating a uniform, exactly positioned and accurately dosed quantity of adhesive is applied such that adhesive travels or spills out neither before nor after compression.

This is achieved according to the invention in that the adhesive is dispensed by the nozzle in the form of dosed droplets.

When reference is made here to dosed droplets of adhesive, it is to be mentioned that already in 1878, in “On the instability of jets”, the physicist Lord Rayleigh was addressing the phenomenon of the decomposition of liquid jets and the formation of drops, having noted that a liquid jet tends to decompose into random individual droplets. However, not until 1948 was a device applied for, in U.S. Pat. No. 2,566,443 by Siemens Elema, Sweden, which creates a capillary jet by means of a nozzle. In order to obtain defined droplets the emerging jet has high-frequency pressure waves superimposed on it.

In addition to this system, also known as continuous jet, application technology developed further in 1970 and 1971 through several patent applications, in particular in the ink-jet printing process, to the point of the drop-on-demand system, wherein individual, accurately dosed droplets can be created on call order. Today there are a large number of different systems for the contact-less application of liquid droplets by means of nozzles with capacities in the microlitre range.

The very first of these drop-on-demand systems operated with piezoelectric actuators. Especially nozzles with piezoelectric actuators possibly in a temperable version are suitable specifically for accurately dosed application (dosing accuracy approx. ±2%) of droplets of adhesive, as they can impart a particularly great momentum to the mostly higher-viscosity adhesives and are also suitable as a drive means for needle nozzles operating at very high speed. With dosing frequencies up to 1,000 Hz the requirements as regards high adhesive application rates in practice can be met. Only very small droplets of adhesive measuring 0.1-0.3 mm are possible at a veneer thickness of usually 0.5 mm. However, in order to create a continuous and adequate adhesive bead a large number of droplets is required which must be applied in a very short time at high application rates. Needle nozzles also offer the advantage, especially when applying adhesive, that the needle seals the nozzle opening off tightly and can thus prevent the adhesive from hardening and leaking.

The high momentum in the piezoelectric drive of the droplets is also advantageous for overcoming the high bonding forces or also surface tension forces (adhesion forces) which occur during the microdosing of adhesives. Whenever adhesives come into contact with surfaces such as e.g. nozzle openings, they adhere and inevitably lead to problems, as adhesive is built up on the nozzle opening and the drops no longer coming off cleanly, and in extreme cases the nozzle can even be clogged by hardening adhesive.

The smaller the droplet size, the greater the bonding forces. Newly developed very powerful piezoelectric actuators allow very high acceleration forces to be generated which overcome this strong bonding force of adhesives and make very small droplet sizes possible.

The greater adhesive force of small dosed droplets of adhesive is also significant when they reach the surface to be glued. They cannot burst, because the necessary energy for the formation of a new surface is too small for this. Therefore this method is ideal if very precise positioning and dosing, without atomization, are to be possible. The application of further adhesive is no longer absolutely necessary if every droplet of adhesive is available at the defined position with the accurately dosed quantity.

Since a major problem, namely contamination with adhesive in the application range, is also thereby avoided, the veneer edge can also for the first time be guided accurately in the application range, which in turn is a precondition for high-precision positioning. Even small quantities of adhesive on the guide surfaces would already be enough to lead to inaccuracies or even to the interruption of the application. In particular in the case of thin veneers it could lead to the splitting-off of small slivers or wood fibres which, in conjunction with adhesive, would build up into extremely hard encrustations.

Common to all systems for the contact-less application by means of nozzles of liquid droplets with capacities in the microlitre range is the high speed through the air of droplets approx. 1.5 to 3 m/s, so that the application edge can be very uneven or undulating and be distanced, as required, apart from a few millimetres. This property is particularly advantageous because in particular thin veneer sheets, as a naturally grown material—its character determined by the type of wood, the fibre pattern and machining—differ so greatly in their features that no two pieces are the same. Thus it would be practically impossible to maintain the distance from the nozzle in the application range with low tolerances, as the features named above, above all the different fibre pattern and the undulation, can repeatedly lead to a flow of a few millimetres, particularly at high application rates.

On the other hand, guide elements in the application range are particularly important because the veneer edge must be guided absolutely play-free or centred in the application plane of the nozzle. Only thereby the exact application position of the droplets of adhesive can be advantageously achieved in the exact centre of the edge.

In addition to the exact application position, the dosing can be accurately controlled by the size and the frequency of application of the droplets of adhesive. The aim is to apply just enough adhesive to the edge that upon compression the whole edge is wetted if at all possible, but no adhesive spills out.

Additionally, several nozzles can be connected in series, so that either operation is possible at higher application rates or else one or several parallel beads are obtained by many small overlapping droplets.

For specific applications, just single adhesion points at varying distances are also conceivable. In this connection it is particularly to be mentioned that one is not restricted to any specific direction of application, thus there is no dependence on gravitation.

Further features and advantages of the invention are explained in more detail with the help of the drawings described below.

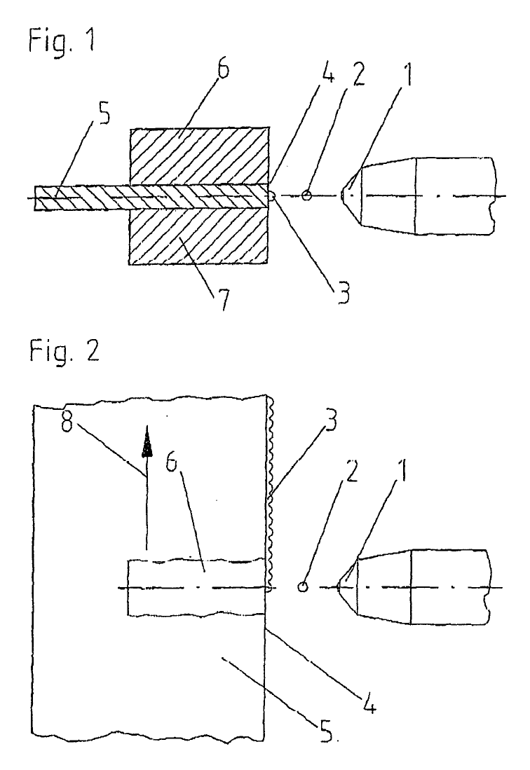

FIG. 1 shows schematically a device for applying droplets of adhesive to a workpiece, shown in side view of the planes of the application movement and in section.

FIG. 2 shows the application device, also schematically, but in this case the top view.

In both representations, the application nozzle, the course of the droplets of adhesive with the adhesive bead, the workpiece and workpiece guides are represented in simplified form.

According to the represented embodiment example, the method according to the invention is to be used for the application, contact-less and dosed in droplet form, by means of one or more nozzles 1, of droplets of adhesive 2 to the strip-shaped surface, in particular the edge 4, of thin, film-type workpieces.

For this purpose, as shown in FIG. 2, the workpiece 5 is moved past in direction 8 relative to the nozzle 1, wherein upon impact the droplets of adhesive 2 created by the nozzle 1 touch one another or overlap to a greater or lesser extent and thus create a continuous and regular beading of adhesive 3. The quantity of adhesive can be accurately dosed and also the application pattern configured at will through the frequency of application of the droplets of adhesive in relation to the application rate, but also through the number and arrangement of the nozzles 1 used. Thus individual adhesive points can also be created at any desired distances.

In FIG. 1 the guide elements 6, 7 are depicted schematically in a top view. The workpiece 5 is guided or centred absolutely play-free at the moment of impact of the droplets of adhesive 2 in the application plane of the nozzle 1. Only in this way can the exact application position of the droplets of adhesive advantageously be achieved exactly in the centre of the application edge 4 during the application movement in direction 8. Because of the high speed through the air of the droplets 2 a stable application result is also guaranteed with irregular workpiece edges, in particular if the distance between nozzle 1 and application edge 4 varies.

All materials that have proved successful in the gluing of veneers which can be applied in the form of dosed drops come into consideration. Reactive hot-melt adhesives based on polyurethane have in particular proved successful.

Microdosing valves, in particular those with a piezo drive with which the method according to the invention can be carried out, are supplied by various manufacturers, for example PICODOSTEC GmbH.

The novel gluing technique according to the invention has already led to a new area of application for veneer sheets made of strips glued blunt-ended together: the proposal to provide honeycomb sheets with single-ply top layers made of solid wood has thus far found no use in practice, as only relatively thick and thus expensive sheets could be glued together. In order to reduce costs, veneered sheets of plywood were therefore used as top layer. However, by means of the invention it is possible to make the reciprocal joining of the veneer strips so thick that the only lower limit to the thickness of the top layer is its static function. Honeycomb sheets whose top layers are built up only from strips of sawn veneer glued blunt-ended together thereby become economically attractive.

1. Method for applying adhesive to the narrow side of thin, film-type workpieces, in particular veneer strips or sheets, wherein the workpiece and at least one nozzle dispensing the adhesive substantially perpendicular to the narrow side of the workpiece are guided at a short distance from each other, characterized in that the adhesive is dispensed by the nozzle in the form of dosed droplets.

2. Honeycomb sheet with at least one single-ply top layer of solid wood, characterized in that the top layer consists of veneer strips which are connected to each other by the method according to claim 1.
